(19) United States
(12) Patent Application Publication
(10) Pub. No.: US 2004/0162385 A1
(43) Pub. Date: Aug. 19, 2004

(54) Reactive polyurethanes having reduced diisocyanate monomer content

(76) Inventor: Michael Krebs, Hilden (DE)

Correspondence Address: HENKEL CORPORATION, THE TRIAD, SUITE 200, 2200 RENAISSANCE BLVD., GULPH MILLS, PA, 19406, US

(21) Appl. No.: 10/755,702

(22) Filed: Jan. 12, 2004

Related U.S. Application Data
(63) Continuation of application No. PCT/EP02/07344, filed on Jul. 3, 2002.

(30) Foreign Application Priority Data
Jul. 10, 2001 (DE) 101 132 571.1

(51) Int. Cl. C08K 3/00

(52) U.S. Cl. 524/589

(57) ABSTRACT

Reactive polyurethanes containing free isocyanate groups but low levels of monomeric asymmetrical diisocyanate may be obtained by reacting a monomeric asymmetrical diisocyanate such as diphenylmethane-2,4′-diisocyanate (2,4′-MDI) containing less than 5% 4,4′-MDI and 2,2′-MDI, the 2,2′-MDI content being under 0.4%, with a polyhydric alcohol such as a diol with a molecular weight of 60 g/mol to 2,000 g/mol. The ratio of isocyanate groups to hydroxyl groups may be a value of 1.05:1 to 2.0:1. The reactive polyurethanes can be used to produce one- and two-component adhesive and sealant products.

This application is a continuation under 35 USC Sections 365(c) and 120 of International Application No. PCT/EP02/07344, filed 3 Jul. 2002 and published 23 Jan. 2003 as WO 03/006521, which claims priority from German Application No. 10132571.1, filed 10 Jul. 2001, each of which is incorporated herein by reference in its entirety.

### FIELD OF THE INVENTION

This invention relates to reactive polyurethanes with a low content of monomeric diisocyanates, to their production and to their use in reactive one- and two-component adhesives/sealants, assembly foams, potting compounds and in flexible, rigid and integral foams.

### DISCUSSION OF THE RELATED ART

Reactive polyurethanes have reactive terminal groups which are capable of reacting with water or other compounds which contain an acidic hydrogen atom. This form of reactivity enables the reactive polyurethanes to be brought in the required form to the required place in the processable state (generally liquid to highly viscous) and to cure by the addition of water or other compounds containing an acidic hydrogen atom (known in this case as hardeners). With these so-called two-component systems, the hardener is generally added immediately before application, normally using a mixing and dosing system, only a limited processing time being available to the processor after addition of the hardener. However, polyurethanes containing reactive terminal groups can also be cured without the addition of hardeners, i.e., solely by reaction with atmospheric moisture (one-component systems). One-component systems generally have the advantage over two-component systems that the user is spared the often laborious mixing of the frequently viscous components before application. The polyurethanes terminated by reactive groups which are normally used in one-component or two-component systems include, for example, the polyurethanes containing preferably terminal isocyanate (NCO) groups.

In order to obtain NCO-terminated polyurethanes, it is common practice to react polyhydric alcohols with an excess of monomeric polyisocyanates—generally diisocyanates. It is known that, irrespective of the reaction time, a certain quantity of the monomeric diisocyanate used in excess is left over after the reaction. The presence of monomeric diisocyanate is problematical, for example, in the processing of adhesives and sealants based on reactive polyurethanes. Even at room temperature, diisocyanates, such as IPDI or TDI, have a significant vapor pressure. This significant vapor pressure is serious above all in the case of spray application because, in this case, significant quantities of isocyanate vapors can occur over the application unit. Isocyanate vapors are toxic in view of their irritating and sensitizing effect. Whereas sealants are normally applied at room temperature, adhesives are frequently applied at elevated temperatures. Thus, the application temperatures for hotmelt adhesives are in the range from 100 to 200° C. while those for lamination adhesives are in the range from 30 to 150° C. At temperatures of this order in conjunction with other specific application parameters, such as air humidity for example, the widely used bicyclic diisocyanates (particularly diphenylmethane diisocyanates), for example, form gaseous and aerosol-like emissions. Accordingly, the user has to take elaborate measures to protect the people responsible for applying the. product, more particularly elaborate measures for keeping the surrounding air fit to inhale, as legally stipulated by the maximum permitted concentration of working materials as gas, vapor or particulate matter in the air at the workplace (annually updated “MAK-Wert-Liste der Technischen Regel TRGS 900 des Bundesministeriums für Arbeit und Soziales”).

Since protective and cleaning measures generally involve considerable financial investment or costs, there is a need on the part of the user for products which have a low content of monomeric diisocyanates. However, problems are caused not only by the use, but also the by the marketing of reactive adhesives which still contain monomeric polyisocyanate. Thus, substances and preparations containing, for example, more than 0.1% free MDI or TDI come under the law on hazardous materials and have to be labeled accordingly. The obligation to do so involves special measures for packaging and transportation. The presence of monomeric unreacted starting diisocyanate often leads to problems during further processing. For instance, monomeric diisocyanates are capable of “migrating” from the coating or bond into the coated or bonded materials. Such migrating constituents are commonly known among experts as “migrates”. By contact with moisture, the isocyanate groups of the migrates are continuously reacted to amino groups and other metabolites. In polyurethane integral foams which are used, for example, in the production of steering wheels for motor vehicles, such migrates are undesirable because contact of the amines formed from the migrated diisocyanates with the skin cannot be ruled out. Migrates are also undesirable in the packaging industry and particularly in the packaging of foods. On the one hand, the passage of the migrates through the packaging material can lead to contamination of the packaged product; on the other hand, depending on the quantity of migratable, free monomeric diisocyanate, long waiting times are necessary before the packaging material is “migrate-free” and can be used. The content of the amines, particularly primary aromatic amines, thus formed must be below the detection limit—based on aniline hydrochloride—of 0.2 micrograms aniline hydrochloride/100 ml sample (Bundesinstitut für gesundheitlichen Verbraucherschutz und Veterinärmedizin, BGVV, nach amtlicher Sammlung von Untersuchungsverfahren nach § 35 LMBG—Untersuchung von Lebensmitteln/Bestimmung von primären aromatischen Aminen in wässrigen Prüflebensmitteln). Another unwanted effect which can be caused by the migration of monomeric diisocyanates is the so-called antisealing effect in the production of bags or carrier bags from laminated plastic film. The laminated plastic films often contain a lubricant based on fatty acid amides. By reaction of migrated monomeric diisocyanate with the fatty acid amide and/or moisture, urea compounds with a melting point above the sealing temperature of the plastic films are formed on the surface of the film. This leads to the formation between the films to be sealed of a “foreign” antisealing layer which counteracts the formation of a homogeneous sealing seam.

Accordingly, there is a high demand in the fields of application mentioned for the development of reactive polyurethanes and one- and two-component adhesives/sealants, assembly foams, potting compounds and flexible, rigid and integral foams based thereon having a drastically reduced content of monomeric diisocyanates.

Thus, EP-A-316 738 describes a process for the production of urethane polyisocyanates having a urethane-free starting diisocyanate content of at most 0.4% by weight by reaction of aromatic diisocyanates with polyhydric alcohols and subsequent removal of the unreacted excess starting diisocyanate, the removal of the excess starting diisocyanate by distillation taking place in the presence of an aliphatic polyisocyanate containing isocyanate groups.

DE 3815237 A1 describes a process for reducing the monomer content of urethane- or isocyanurate-modified polyisocyanates based on 2,4-TDI or a mixture thereof containing up to 35% by weight 2,6-TDI or IPDI. The monomer content is reduced by optionally thin-layer distillation and subsequent reaction with water.

EP-A-0 393 903 describes a process for the production of polyurethane prepolymers in which, in a first step, monomeric diisocyanate is reacted with a polyol. A catalyst is then added in a quantity sufficient for the conversion of a considerable part of the remaining isocyanate functionality into allophanate functionality. After the theoretical NCO content has been reached, the reaction is terminated by rapid cooling and addition of salicylic acid.

WO 01/40342 describes reactive polyurethane sealant/adhesive compositions based on reaction products of polyols and high molecular weight diisocyanates. In a first step, a diol component is reacted with a stoichiometric excess of monomeric diisocyanate to form a high molecular weight diisocyanate and the resulting high molecular weight diisocyanate is precipitated from the reaction mixture, for example by addition of a non-solvent for the high molecular weight diisocyanate. In a second step, the high molecular weight diisocyanate is reacted with a polyol to form an isocyanate-terminated reactive prepolymer.

DE 4136490 A1 relates to low-migration, solventless two-component coating, sealing and adhesive systems of polyols and isocyanate prepolymers. The NCO prepolymers are prepared by reaction of polyol mixtures having an average functionality of 2.05 to 2.5 and at least 90 mol-% secondary hydroxyl groups and diisocyanates containing isocyanate groups differing in their reactivity in a ratio of the isocyanate groups to hydroxyl groups of 1.6 to 1.8:1. Table 1 on page 5 shows that MDI prepolymers prepared in accordance with the teaching of DE 4136490 A1 have a monomer content of greater than 0.3%.

Despite the prior art cited above, there -continues to be a demand for reactive polyurethanes with a low percentage content of monomeric diisocyanates which are suitable both for use as reactive one- and two-component adhesives/sealants, more particularly for reactive hotmelt adhesives or lamination adhesives and for the production of assembly foams, potting compounds and flexible, rigid and integral foams.

Accordingly, one problem addressed by the invention was to provide polyurethanes for use as adhesives or sealants which would be monomer-free or would have a low content of monomeric diisocyanates. Ideally, these polyurethanes would not have to labeled as hazardous materials.

To achieve a low content of monomeric diisocyanates in the prior art, complicated and expensive purification steps have to be carried out. Specific examples include the removal of excess monomeric diisocyanates by selective extraction, for example with supercritical carbon dioxide, thin-layer distillation, thin-film evaporation or precipitation of the reactive polyurethane from the reaction mixture containing monomeric diisocyanates. Accordingly, another problem addressed by the invention was to provide reactive polyurethanes which would have a low monomeric diisocyanate content without any need for complicated purification steps.

### BRIEF SUMMARY OF THE INVENTION

The present invention provides reactive polyurethanes with an NCO content of 4-12% NCO and a content of monomeric asymmetrical diisocyanates of 0.01 to 0.3% by weight, obtainable by reaction of

I. at least one monomeric asymmetrical diisocyanate having a molecular weight of 160 g/mol to 500 g/mol with

II. at least one diol having a molecular weight of 60 g/mol to 2,000 g/mol,

the ratio of isocyanate groups to hydroxyl groups being 1.05:1 to 2.0:1,

a) at a temperature of 20° C. to 130° C., preferably 25° C. to 100° C. and more particularly 40 to 70° C.,

b) optionally in the presence of a catalyst and

c) optionally in the presence of an aprotic solvent

without additional working-up and purification steps.

The reactive polyurethane thus obtained contains 0.01 to 0.3% by weight, preferably 0.02 to 0.1% by weight and more particularly 0.02 to 0.08% by weight of monomeric asymmetrical diisocyanate.

### DETAILED DESCRIPTION OF CERTAIN EMBODIMENTS OF THE INVENTION

Reactive polyurethanes in the context of the present invention are understood to be compounds which are solid, paste-like or liquid at room temperature, contain urethane groups and still have free isocyanate (NCO) groups.

The NCO content of the reactive polyurethane according to the invention is from 4 to 12% NCO, preferably from 4.5 to 10% NCO and more particularly from 5 to 8% NCO.

The Brookfield viscosity (as measured to ISO 2555) of the reactive polyurethane according to the invention is in the range from 20 mPas to 3,000 mPas and preferably in the range from 25 mPas to 2,000 mPas at 100° C.

Monomeric asymmetrical diisocyanates in the context of the invention are aromatic, aliphatic or cycloaliphatic diisocyanates with a molecular weight of 160 g/mol to 500 g/mol which contain NCO groups differing in their reactivity to diols. The differing reactivity of the NCO groups of the diisocyanate is attributable to differently adjacent substituents to the NCO groups on the molecule which reduce the reactivity of one NCO group compared with the other NCO group, for example by steric screening and/or by different bonding of one NCO group to the rest of the molecule, for example in the form of a primary or secondary NCO group.

Examples of suitable aromatic asymmetrical diisocyanates are any isomers of toluene diisocyanate (TDI) either in pure form or in the form of a mixture of several isomers, naphthalene-1,5-diisocyanate (NDI), naphthalene-1,4-diisocyanate (NDI), diphenylmethane-2,4′-diisocyanate (MDI) and mixtures of 4,4′-diphenylmethane diisocyanate with the 2,4′-MDI isomer and 1,3-phenylene diisocyanate.

Examples of suitable cycloaliphatic asymmetrical diisocyanates include 1-isocyanatomethyl-3-isocyanato-1,5,5-trimethyl cyclohexane (isophorone diisocyanate, IPDI), 1-methyl-2,4-diisocyanatocyclohexane or hydrogenation products of the aromatic diisocyanates mentioned above, more particularly hydrogenated MDI in the form of the pure isomer, preferably hydrogenated 2,4′-MDI.

Examples of aliphatic asymmetrical diisocyanates are 1,6-diisocyanato-2,2,4-trimethylhexane, 1,6-diisocyanato-2,4,4-trimethylhexane and lysine diisocyanate.

The use of 2,2′/2,4′/4,4′-MDI mixtures containing more than 75% of the 2,4′-MDI isomer, for example for the production of polyurethane (PUR) adhesives, is well-known. According to the invention, diphenylmethane-2,4′-diisocyanate (2,4′-MDI) containing less than 25%, preferably less than 5% and more particularly less than 2.5% 4,4′-MDI and 2,2′-MDI is used as the monomeric asymmetrical diisocyanate. In one particular embodiment, the 2,2′-MDI content is under 0.4%.

In another particular embodiment of the invention, the polyisocyanates or capped polyisocyanates are added to the reaction mixture of monomeric asymmetrical diisocyanate and diol after most of the monomeric asymmetrical diisocyanate has reacted.

In another particular embodiment of the invention, the more reactive NCO group of the monomeric asymmetrical diisocyanate is selectively blocked with a protective group. The blocking agent is selected so that it is not eliminated during the reaction of the less reactive NCO group of the blocked monomeric asymmetrical diisocyanate with the corresponding polyol, i.e. the reaction takes place under relatively mild conditions, for example at temperatures of up to at most 70° C. and optionally in the presence of an apolar solvent. Overcoming the isocyanate blockade and hence activating the reactive adhesive produced with the blocked isocyanate requires thermal activation. Activation temperatures for such PU reactive adhesives are in the range from 70° C. to 180° C.

The blocking agent is preferably removed from the reaction mixture, for example by distillation, during or after the activation step. Blocking may be carried out with the usual blocking agents, for example butanone oxime, phenol, ethyl acetoacetate, malonic ester, dimethylpyrazole or caprolactam. Caprolactam is preferably used, although combinations of several of the compounds mentioned are may also be used.

The diols used for the production of the reactive polyurethanes according to the invention have a molecular weight of 60 g/mol to 2,000 g/mol and preferably 200 g/mol to 1,500 g/mol. The OH value of the diol as determined to DIN 53240 is crucial to the molecular weight. Basically, any linear or lightly branched C₂₋₁₈ alkanediols may be used for this purpose. In addition, low molecular weight polyethers and low molecular weight alkoxylation products of aromatic dihydroxy compounds (diphenols) may be used. Diols containing secondary hydroxy groups are particularly suitable. Examples of the diols to be used in accordance with the invention are ethylene glycol, propane-1,2-diol, propane-1,3-diol, 2,2-dimethylpropane-1,3-diol, 2-methyl propanediol, hexane-1,6-diol, 2,4,4-trimethylhexane-1,6-diol, 2,2,4-trimethylhexane-1,6-diol, 1,4-cyclohexane dimethanol, diethylene glycol, triethylene glycol, tetraethylene glycol, dipropylene glycol, tripropylene glycol, tetrapropylene glycol, poly(oxytetramethylene)glycol, homopolymers of polyethylene glycol with an average molecular weight (number average Mₙ) of up to 2,000, homopolymers of propylene glycol with an average molecular weight (number average Mₙ) of up to 2,000, block copolymers and statistical (random) copolymers of ethylene glycol and propylene glycol with an average molecular weight (number average Mₙ) of up to 2,000, alkoxylation products of bisphenol A, alkoxylation products of bisphenol F, isomeric dihydroxyanthracenes, isomeric dihydroxynaphthalenes, pyrocatechol, resorcinol, hydroquinone with up to 8 alkoxy units per aromatic hydroxy group or mixtures of the diols mentioned.

In addition, reaction products of low molecular weight polyhydric alcohols with alkylene oxides, so-called polyethers, are used as diols. The alkylene oxides preferably contain 2 to 4 carbon atoms. Suitable reaction products are, for example, those of ethylene glycol, propylene glycol, isomeric butanediols, hexanediols or 4,4′-dihydroxy diphenylpropane with ethylene oxide, propylene oxide or butylene oxide or mixtures of two or more thereof.

In one particular embodiment of the invention, the monomeric asymmetrical diisocyanates are reacted with a mixture of diol and polyol. This mixture preferably contains 1 to 40% by weight of a polyol from the group consisting of glycerol, trimethylol ethane or trimethylol propane, pentaerythritol or sugar alcohols or a mixture of two or more thereof; the polyols may be reacted with the above-mentioned alkylene oxides to form polyether polyols. Both random and block polyether polyols with a molecular weight of about 100 g/mol to 1,800 g/mol are suitable.

In another particular embodiment of the invention, a mixture of a diol having a molecular weight of 60 g/mol to 2,000 g/mol and a polyol having a molecular weight (Mₙ) of 2,000 g to 20,000 g/mol and preferably in the range from 4,000 to 8,000 g/mol is used. The polyol may be, for example, a polymer selected from the group consisting of polyesters, polyethers, polyacetals and polycarbonates. The percentage content of the polyol in the mixture with diol is between 5 and 30% by weight.

The reactive polyurethanes according to the invention preferably also contain catalysts which accelerate the formation of the reactive polyurethane during the production process. It has surprisingly been found that the use of, above all, organometallic compounds as the catalyst leads to polyurethanes with a very small residual monomer content. Catalysts suitable for use in accordance with the invention include, for example, the organometallic compounds of tin, lead, iron, titanium, bismuth or zirconium, such as tetraisopropyl titanate, lead phenyl ethyl dithiocarbamate, tin(II) salts of carboxylic acids, for example tin(II) acetate, ethylhexoate and diethylhexoate. Another class of compounds are the dialkyl tin(IV) carboxylates. The carboxylic acids contain 2, preferably at least 10 and more particularly 14 to 32 carbon atoms. Dicarboxylic acids may also be used. Acids which may be expressly mentioned include adipic acid, maleic acid, fumaric acid, malonic acid, succinic acid, pimelic acid, terephthalic acid, phenylacetic acid, benzoic acid, acetic acid, propionic acid and 2-ethylhexanoic acid, caprylic acid, capric acid, lauric acid, myristic acid, palmitic acid and stearic acid. According to the invention, particularly preferred catalysts are organometallic compounds from the group of tin(IV) compounds. Actual compounds are dibutyl and dioctyl tin diacetate, maleate, bis-(2-ethylhexoate), dilaurate, dichloride, bisdodecyl mercaptide; tributyl tin diacetate; bis-(β-methoxycarbonylethyl)-tin dilaurate and bis-(β-acetylethyl)-tin dilaurate.

Tin oxides and sulfides and tin thiolates may also be used. Actual examples include bis-(tributyltin)-oxide, bis-(trioctyltin)-oxide, dibutyl and dioctyl tin bis-(2-ethylhexylthiolate), dibutyl and dioctyl tin didodecyl thiolate, bis-(β-methoxycarbonylethyl)-tin didodecyl thiolate, bis-(β-acetylethyl)-tin bis-(2-ethylhexylthiolate), dibutyl and dioctyl tin didodecyl thiolate, butyl and octyltin tris-(thioglycolic acid-2-ethylhexoate), dibutyl and dioctyl tin bis-(thioglycolic acid-2-ethylhexoate), tributyl and trioctyl tin bis-(thioglycolic acid-2-ethylhexoate) and butyl and octyl tin tris-(thioethyleneglycol-2-ethylhexoate), dibutyl and dioctyl tin bis-(thioethyleneglycol-2-ethylhexoate), tributyl and trioctyl tin bis-(thioethyleneglycol-2-ethylhexoate) with the general formula Rₙ₊₁Sn(SCH₂CH₂OCOC₈H₁₇)₃₋ₙ, where R is a C₄₋₈ alkyl group, bis-(β-methoxycarbonylethyl)-tin bis-(thioethyleneglycol-2-ethylhexoate), bis-(β-methoxycarbonylethyl)-tin bis-(thioglycolic acid-2-ethylhexoate) and bis-(β-acetylethyl)-tin bis-(thioethyleneglycol-2-ethylhexoate) and bis-(β-acetylethyl)-tin bis-(thioglycolic acid-2-ethylhexoate).

Suitable organobismuth compounds are, in particular, bismuth carboxylates, the carboxylic acids containing 2 to 20 carbon atoms and preferably 4 to 14 carbon atoms. Acids which may be expressly mentioned include butyric acid, caproic acid, caprylic acid, capric acid, lauric acid, myristic acid, palmitic acid, stearic acid, arachic acid, isobutyric acid and 2-ethylhexanoic acid. Mixtures of bismuth carboxylates with other metal carboxylates, for example tin carboxylates, may also be used.

Other suitable catalysts are bases, such as alkali metal hydroxides, alcoholates and phenolates. However, it is pointed out that these catalysts could catalyze unwanted secondary reactions, for example trimerization.

The present invention also relates to a process for the production of reactive polyurethanes with an NCO content of 4 to 12% NCO and a content of monomeric asymmetrical diisocyanates of 0.01 to 0.3% by weight by reaction of

I. at least one monomeric asymmetrical diisocyanate having a molecular weight of 160 g/mol to 500 g/mol with

II. at least one diol having a molecular weight of 60 g/mol to 2,000 g/mol,

the ratio of isocyanate groups to hydroxyl groups being 1.05:1 to 2.0:1,

a) at a temperature of 20° C. to 130° C. and preferably at a temperature of 25° C. to 100° C.,

b) optionally in the presence of a catalyst and

c) optionally in the presence of an aprotic solvent

without additional working-up and purification steps.

The reaction of the monomeric asymmetrical diisocyanates with the diols takes place at a temperature in the range from 20° C. to 130° C., preferably at a temperature in the range from 25° C. to 100° C. and more particularly at a temperature in the range from 40 to 75° C.

In one particular embodiment, the reaction of the monomeric asymmetrical diisocyanates with the diols is carried out at room temperature. In another particular embodiment, the reaction of the monomeric asymmetrical diisocyanates with the diols takes place between 50° C. and 80° C. without continuous mechanical mixing, for example by stirring, of the reaction mixture,

This has the advantage that, rather than in a reactor, the reaction can be carried out in a vat, container or tank.

In one particularly preferred embodiment, the reaction is carried but between 30° C. and 100° C. in the presence of a tin(IV) compound as catalyst.

The NCO:OH ratio in the first stage of the reaction is 1.1 to 2.0:1, preferably 1.2 to 1.95:1 and more particularly 1.4 to 1.9:1.

In another preferred embodiment, the selectivity of the reaction is further increased by reacting the monomeric asymmetrical diisocyanates with the diols in aprotic solvents. The percentage by weight of monomeric asymmetrical diisocyanates and diols in the mixture containing the aprotic solvent is from 20 to 80% by weight, preferably from 30 to 60% by weight and more particularly from 35 to 50% by weight. The reaction in the aprotic solvents takes place at temperatures in the range from 20° C. to 100° C., preferably at temperatures in the range from 25° C. to 80° C. and more particularly at temperatures in the range from 40° C. to 75° C. Aprotic solvents in the context of the invention are, for example, halogen-containing organic solvents, preferably acetone, methyl isobutyl ketone or ethyl acetate.

In another particular embodiment, the solvent is distilled off after termination of the reaction. The reactive polyurethane obtained contains at most 0.3% by weight, preferably at most 0.1% by weight and more particularly at most 0.03% by weight monomeric diisocyanate, based on the reactive polyurethane. The percentage by weight of the monomeric diisocyanate is determined by gas chromatography, by high-pressure liquid chromatography (HPLC) or by gel permeation chromatography (GPC).

The Brookfield viscosity of the reactive polyurethane according to the invention at 100° C., as measured to ISO 2555, is in the range from 20 mPas to 3,000 mPas, preferably in the range from 50 mPas to 1,500 mPas and more particularly in the range from 100 mPas to 1,000 mPas.

In a second stage, the monomer-free or low-monomer reactive polyurethane thus produced is reacted with polyols in known manner at 90° C. to 150° C. and preferably at 110° C. to 130° C. to form an isocyanate-terminated reactive polyurethane composition. The NCO:OH ratio is 1.2:1 to 5:1. Since the reactive polyurethane is already very largely monomer-free, higher NCO:OH ratios of up to 10:1 may also be used in the second reaction stage.

Several relatively high molecular weight polyhydroxy compounds may be used as the polyols. Suitable polyols are, preferably, the polyhydroxy compounds containing two or three hydroxyl groups per molecule which are liquid, glass-like and amorphous or crystalline at room temperature and which have molecular weights in the range from 400 to 20,000 and preferably in the range from 1,000 to 6,000. Examples are difunctional and/or trifunctional polypropylene glycols although statistical and/or block copolymers of ethylene oxide or propylene oxide may also be used. Another group of preferred polyethers are the polytetramethylene glycols (poly(oxytetramethylene)glycol, poly-THF) obtained, for example, by the acidic polymerization of tetrahydrofuran. The molecular weight of the polytetramethylene glycols is in the range from 600 to 6,000 and preferably in the range from 800 to 5,000.

Other suitable polyols are the liquid, glass-like and amorphous or crystalline polyesters obtainable by condensation of di- or tricarboxylic acids such as, for example, adipic acid, sebacic acid, glutaric acid, azelaic acid, suberic acid, undecanedioic acid, dodecanedioic acid, 3,3-dimethylglutaric acid, terephthalic acid, isophthalic acid, hexahydrophthalic acid, dimer fatty acid or mixtures thereof with low molecular weight diols or triols such as, for example, ethylene glycol, propylene glycol, diethylene glycol, triethylene glycol, dipropylene glycol, butane-1,4-diol, hexane-1,6-diol, octane-1,8-diol, decane-1,10-diol, dodecane-1,12-diol, dimer fatty alcohol, glycerol, trimethylol propane or mixtures thereof.

Another group of polyols suitable for use in accordance with the invention are the polyesters based on E-caprolactone (also known as “polycaprolactones”). However, polyester polyols of oleochemical origin may also be used. Oleochemical polyester polyols may be obtained, for example, by complete ring opening of epoxidized triglycerides of a fatty mixture containing at least partly olefinically unsaturated fatty acids with one or more alcohols containing 1 to 12 carbon atoms and subsequent partial transesterification of the triglyceride derivatives to form alkyl ester polyols with 1 to 12 carbon atoms in the alkyl group. Other suitable polyols are polycarbonate polyols and dimer diols (Henkel) and also castor oil and derivatives thereof. The hydroxyfunctional polybutadienes known, for example, by the commercial name of “Poly-bd” may also be used as polyols for the compositions according to the invention.

In another particular embodiment of the invention, a compound containing both at least one functional group polymerizable by irradiation and at least one acidic hydrogen atom is used in the second stage of the reaction. A compound containing an acidic hydrogen atom is understood to be a compound which contains an active hydrogen atom attached to an N, O or S atom which can be determined by the Zerewitinoff test. This definition encompasses in particular the hydrogen atoms of water, carboxy, amino, imino, hydroxy and thiol groups.

Irradiation is understood in particular to be exposure to UV light or electron beams. In a particularly preferred embodiment, the compound contains a group containing an olefinically unsaturated double bond as the functional group polymerizable by exposure to UV light or to electron beams. The molecular weight of the compound is in the range from 100 to 15,000 g/mol, preferably in the range from 100 to 10,000 g/mol and more particularly in the range from 100 to 8,000 g/mol.

Any of the polymeric compounds typically used in adhesives are suitable, including for example polyacrylates, polyesters, polyethers, polycarbonates, polyacetals, polyurethanes, polyolefins or rubber polymers, such as nitrile or styrene/butadiene rubber, providing it contains at least one functional group polymerizable by exposure to. UV light or to electron beams and at least one acidic hydrogen atom.

However, polyacrylates, polyester acrylates, epoxy acrylates or polyurethane acrylates are preferably used because these polymers offer a particularly simple way of arranging the functional groups required in accordance with the invention on the polymer molecule.

Linear and/or lightly branched polyacrylates containing OH groups are suitable. Such polyacrylates are obtainable, for example, by polymerization of ethylenically unsaturated monomers containing OH groups. Monomers such as these are obtainable, for example, by esterification of ethylenically unsaturated carboxylic acids and dihydric alcohols, the alcohol generally being present in only a slight excess. Ethylenically unsaturated carboxylic acids suitable for this purpose are, for example, acrylic acid, methacrylic acid, crotonic acid or maleic acid. Corresponding OH-functional acrylate esters or hydroxyalkyl (meth)acrylates are, for example, 2-hydroxyethyl acrylate, 2-hydroxyethyl methacrylate, 2-hydroxypropyl acrylate, 2-hydroxypropyl methacrylate, 3-hydroxypropyl acrylate or 3-hydroxypropyl methacrylate or mixtures of two or more thereof. Acrylate-copolymer polyols can be obtained, for example, by the radical copolymerization of acrylates or methacrylates with hydroxyfunctional acrylic acid and/or methacrylic acid compounds, such as hydroxyethyl (meth)acrylate or hydroxypropyl (meth)acrylate. As a result of this method of production, the hydroxyl groups in these polyols are generally statistically distributed so that the polyols are either linear or lightly branched polyols with an average OH functionality. Although the difunctional compounds are preferred for the polyols, polyols of higher functionality may also be used, at least in small quantities.

In certain circumstances, particularly where water is present, for example on moist surfaces, carbon dioxide can be given off from reactive adhesives based on NCO-terminated polyurethane prepolymers, which can have adverse effects on the surface structure for example. In addition, such reactive adhesives often do not adhere to smooth inert surfaces, for example to surfaces of glass, ceramics, metal or the like, so that a primer sometimes has to be applied before the reactive adhesives. In order to ensure a firm and durable bond between polyurethane-based reactive adhesives and, for example, the surfaces mentioned above, an organosilicon compound, preferably an alkoxysilane group, corresponding to general structural formula (I) below is preferably used as the reactive terminal group in the second stage of the reaction:

X-A-Si(Z)ₙ(OR)₃₋ₙ (I)

in which X is a substituent containing at least one reactive functional group with acidic hydrogen, for example a substituent which contains at least one OH, SH, NH, NH₂, COOH or anhydride group or a mixture of two or more such groups. In a preferred embodiment of the invention, X stands for OH, SH, H₂N—(CH₂)₂—NH, (HO—C₂H₄)₂N or NH₂, A stands for CH₂, CH₂—CH₂ or CH₂—CH₂—CH₂ or for a linear or branched, saturated or unsaturated alkylene group containing 2 to about 12 carbon atoms or for an arylene group containing about 6 to about 18 carbon atoms or for an arylene alkylene group containing about 7 to about 19 carbon atoms or for an alkyl-, cycloalkyl- or aryl-substituted siloxane group containing about 1 to about 20 Si atoms, Z stands for —O—CH₃, —CH₃, —CH₂—CH₃ or for a linear or branched, saturated or unsaturated alkyl group or alkoxy group containing 2 to about 12 carbon atoms and R stands for —CH₃, —CH₂—CH₃, —CH₂—CH₂—CH₃ or for a linear or branched, saturated or unsaturated alkyl group containing 2 to about 12 carbon atoms. In a preferred embodiment of the invention, the variable n has a value of 0, 1 or 2.

In principle, the choice of the polyol or polyols is determined by the intended application of the polyurethane composition containing reactive terminal isocyanate groups. In the case of highly viscous or paste-like liquid adhesives/sealants, liquid polyols are preferably at least predominantly used. In the case of two-component adhesives/sealants, one component may contain the polyurethane compositions with reactive terminal isocyanate groups while the second component may contain a hydroxyfunctional polyol or hydroxyfunctional polyurethane. However, the reactive polyurethane according to the invention may also be used as a hardener for a hydroxyfunctional component, the hydroxyfunctional component containing either one or more of the polyols mentioned above or a hydroxyfunctional polyurethane prepolymer.

Where the reactive polyurethanes according to the invention are used for the production of reactive hotmelt adhesives (PUR hotmelts), the polyol components are selected so that the composition is solid at room temperature. This can be done on the one hand by using amorphous and/or solid crystalline polyhydroxy compounds or, on the other hand, by using a considerable percentage of short-chain polyhydroxy compounds because the high concentration of urethane groups means that these compositions are also solid at room temperature. Selection criteria for the polyols can be found, for example, in the article by H. F. Huber and H. Müller in “Shaping Reactive Hotmelts Using LMW Copolyesters”, Adhesive Age, November, 1987, pages 32 to 35.

PUR hotmelts known from the literature solidify on cooling through crystallization or amorphous solidification of the soft segment (for example a polyester block). A reactive polyurethane with a melting point of 80° C. to 120° C. is obtained by reaction of 2,4′-MDI containing more than 97% 2,4′-MDI and predominantly crystalline diols with a molecular weight of 60 g/mol to 2,000 g/mol. This polyurethane is applied to the substrates to be bonded as a hotmelt in combination with, in particular, liquid polyol hardeners using conventional application techniques and provides for rapid setting with high early strength during cooling.

In order to accelerate the formation of the reactive polyurethane composition during production and/or moisture-induced crosslinking after application of the adhesive/sealant, aliphatic tertiary amines may also be added to the reactive polyurethane according to the invention in addition to the organometallic catalysts already mentioned. Suitable tertiary amines also include those which additionally contain isocyanate-reactive groups, more particularly hydroxyl and/or amino groups. Examples of such tertiary amines are dimethyl monoethanolamine, diethyl monoethanolamine, methylethyl monoethanolamine, triethanolamine, trimethanolamine, tripropanolamine, tributanolamine, trihexanolamine, tripentanolamine, tricyclohexanolamine, diethanol methylamine, diethanol ethylamine, diethanol propylamine, diethanol butylamine, diethanol pentylamine, diethanol hexylamine, diethanol cyclohexyl amine, diethanol phenyl amine and ethoxylation and propoxylation products thereof, diazabicyclooctane (DABCO), triethyl amine, dimethyl benzyl amine (DESMORAPID DB, BAYER), bis-dimethylaminoethyl ether (Catalyst A 1, UCC), tetramethyl guanidine, bis-dimethylaminomethylphenol, 2-(2-dimethylaminoethoxy)-ethanol, 2-dimethylaminoethyl-3-dimethylaminopropyl ether, bis-(2-dimethylaminoethyl)-ether, N,N-dimethyl piperazine, N-(2-hydroxyethoxy-ethyl)-2-azanorbornane, or even unsaturated bicyclic amines, for example diazabicycloundecane (DBU) and TEXACAT DP-914 (Texaco Chemical), N,N,N,N-tetramethylbutane-1,3-diamine, N,N,N,N-tetramethylpropane-1,3-diamine and N,N,N,N-tetramethylhexane-1,6-diamine. The catalysts may also be present in oligomerized or polymerized form, for example as N-methylated polyethylene imine.

However, most particularly preferred catalysts are derivatives of morpholine. Examples of suitable morpholino compounds are bis(2-(2,6-dimethyl-4-morpholino)ethyl)-(2-(4-morpholino)ethyl)amine, bis(2-(2,6-dimethyl4-morpholino)ethyl)-(2-(2,6-diethyl-4-morpholino)ethyl)amine, tris(2-(4-morpholino)ethyl)amine, tris(2-(4-morpholino)propyl)amine, tris(2-(4-morpholino)butyl)amine, tris(2-(2,6-dimethyl-4-morpholino)ethyl)amine, tris(2-(2,6-diethyl4-morpholino)ethyl)amine, tris(2-(2-methyl4-morpholino)ethyl)amine or tris(2-(2-ethyl-4-morpholino)ethyl)amine, dimethyl aminopropyl morpholine, bis-(morpholinopropyl)-methylamine, diethylaminopropyl morpholine, bis-(morpholinopropyl)-ethylamine, bis-(morpholinopropyl)-propylamine, morpholinopropyl pyrrolidone or N-morpholinopropyl-N′-methyl piperazine, 2,2′-dimorpholinodiethyl ether (DMDEE) or di-2,6-dimethylmorpholinoethyl) ether.

The above-mentioned morpholine derivatives show particularly high catalytic activity, particularly in the water(moisture)/isocyanate reaction. Accordingly, even very low catalyst concentrations are highly effective for the crosslinking or curing of the reactive adhesives/sealants, assembly foams, potting compounds and flexible, rigid and integral foams. The concentration of the catalyst added to the reactive polyurethane according to the invention in the adhesive formulation may be between 0.001 and 2% by weight and is preferably between 0.02 and 0.9% by weight.

In addition, the reactive polyurethane according to the invention or the reactive polyurethane composition according to the invention may optionally contain stabilizers, adhesion-promoting additives, such as tackifying resins, fillers, pigments, plasticizers and/or solvents.

“Stabilizers” in the context of the present invention are, on the one hand, stabilizers which stabilize the viscosity of the reactive polyurethane or the reactive polyurethane composition during production, storage and application. Stabilizers suitable for this purpose are, for example, monofunctional carboxylic acid chlorides, monofunctional highly reactive isocyanates and also non-corrosive inorganic acids, for example benzoyl chloride, toluenesulfonyl isocyanate, phosphoric acid or phosphorous acid. Other suitable stabilizers in the context of the invention are antioxidants, UV stabilizers and hydrolysis stabilizers. The choice of these stabilizers is determined on the one hand by the principal components of the reactive polyurethane or the reactive polyurethane composition and, on the other hand, by the application conditions and the stressing which the cured product can be expected to undergo. If the reactive polyurethane or the reactive polyurethane composition consists predominantly of polyether units, antioxidants, optionally in combination with UV stabilizers, are mainly required. Examples of such stabilizers are the commercially available sterically hindered phenols and/or thioethers and/or substituted benzotriazoles or the sterically hindered amines of the HALS (hindered amine light stabilizer) type.

If the reactive polyurethane or the reactive polyurethane composition consists largely of polyester units, hydrolysis stabilizers, for example of the carbodiimide type, may be used.

If the reactive polyurethanes according to the invention or the reactive polyurethane compositions according to the invention are used in hotmelt adhesives, lamination adhesives or adhesive/sealing compounds, they may contain tackifying resins, for example, abietic acid, abietic acid esters, terpene resins, terpene/phenol resins or hydrocarbon resins, and also fillers (for example, silicates, talcum, calcium carbonates, clays or carbon black), plasticizers (for example, phthalates) or thixotropicizing agents (for example, bentones, pyrogenic silicas, urea derivatives, fibrillated or pulped chopped strands) or dye pastes or pigments.

Migratable polyisocyanates are particularly suitable as adhesion-strengthening additives, preferably in reactive hotmelt adhesives. These migratable polyisocyanates should have a considerably lower vapor pressure than MDI. Suitable migratable, adhesion-strengthening polyisocyanates with a considerably lower vapor pressure than MDI are mainly triisocyanates such as, for example, thiophosphoric acid tris-(p-isocyanatophenyl ester), triphenyl methane-4,4′,4″-triisocyanate and, in particular, the various isomeric trifunctional homologs of diphenyl methane diisocyanate (MDI). The homologs in question mainly include isocyanato-bis-((4-isocyanatophenyl)-methyl-benzene, 2-isocyanato-4-((3-isocyanato-phenyl)-methyl)-1-((4-isocyanatophenyl)-methyl)-benzene, 4-isocyanato-1,2-bis-((4-isocyanatophenyl)-methyl)-benzene, 1-isocyanato-4-((2-iso-cyanatophenyl)-methyl)-2-((3-isocyanatophenyl)-methyl)-benzene, 4-iso-cyanato-α-1-(o-isocyanatophenyl)-α,3-(p-isocyanatophenyl)-m-xylene, 2-isocyanato-(o-isocyanatophenyl)-α-(p-isocyanatophenyl)-m-xylene, 2-isocyanato-1,3-bis-((2-isocyanatophenyl)-methyl)-benzene, 2-isocyanato-1,4-bis-((4-isocyanatophenyl)-methyl)-benzene, isocyanato-bis-((isocyanatophenyl)-methyl)-benzene, 1-isocyanato-2,4-bis-((bis-((4-isocyanatophenyl)-methyl)-benzene and mixtures thereof, optionally with a small amount of higher homologs. Since the trifunctional homologs of diphenyl methane diisocyanate are produced similarly to diphenyl methane diisocyanate by condensation of formaldehyde with aniline and subsequent phosgenation, the technical mixture of the trifunctional homologs of MDI also contains diisocyanate, although it should not be present in quantities of more than 20% by weight, based on the triisocyanate mixture; the percentage content of polyisocyanates having a functionality of 4 or higher should be no more than 25% by weight.

In addition, adducts of diisocyanates and low molecular weight triols, more particularly the adducts of aromatic diisocyanates and triols, for example trimethylol propane or glycerol, are also suitable as triisocyanates. The above-mentioned limitations in regard to the diisocyanate content and the content of polyisocyanates with a higher functionality apply to these adducts also.

Aliphatic triisocyanates, such as for example the biuretization product of hexamethylene diisocyanate (HDI) or the isocyanuratization of HDI or even the same trimerization products of isophorone diisocyanate (IPDI) are also suitable for the compositions according to the invention providing the percentage content of diisocyanates is less than 1% by weight and the percentage content of tetra- and higher isocyanates is no more than 25% by weight.

By virtue of their ready availability, the above-mentioned trimerization products of HDI and IPDI are particularly preferred.

The migratable polyisocyanates mentioned above may be directly used in the second reaction stage for the production of the reactive polyurethane composition. Another possibility is to incorporate the adhesion-strengthening migratable polyisocyanates separately in a subsequent formulation step.

Where the compositions according to the invention are used as lamination adhesives, epoxy resins, phenolic resins, novolaks, resols or melamine resins and the like may be added to achieve certain additional properties, such as thermal and chemical stability. In addition, the reactive polyurethane compositions may even be prepared in the form of solutions, preferably in polar aprotic solvents, in this case. The preferred solvents have a boiling range of around 50° C. to 140° C. Although halogenated hydrocarbons are also suitable, ethyl acetate, methyl ethyl ketone (MEK) and acetone are most particularly preferred.

The reactive polyurethanes according to the invention and the reactive polyurethane compositions produced from them are used in reactive one- and two-component adhesives/sealants, assembly foams, potting compounds and in flexible, rigid and integral foams. In the same way as typical known polyurethane adhesives/sealants for example, they are used as reactive one- or two-component adhesives/sealants, as reactive hotmelt adhesives or as solvent-containing adhesives in one or two-component form. The major advantage over known reactive one- and two-component adhesives/sealants, assembly foams, potting compounds and flexible, rigid and integral foams lies in the significantly low percentage of physiologically problematic monomeric diisocyanates with a molecular weight below 500 g/mol. Another advantage over known low-monomer reactive polyurethanes is an economic one because the low monomer content is achieved without complicated and expensive working-up steps. The moderate, selective reaction gives reactive polyurethanes which are free, for example, from the secondary products typically formed in thermal working-up steps, such as crosslinking or depolymerization products. The selective reaction of asymmetrical diisocyanates with secondary diols gives sterically shielded reactive polyurethanes which in turn give polyurethane hotmelt adhesives with excellent melt stability.

The following Examples are intended to illustrate the invention.

### EXAMPLES

### 1. Production of Reactive Polyurethanes

The reactive polyurethanes listed in Table 1 were produced by heating a pure 2,4′-MDI containing at least 97.5% 2,4′-isomers as the monomeric asymmetrical diisocyanate to a temperature of 50° C. The heating was then switched off and commercially available polypropylene glycol with a molecular weight of ca. 760 was added over a period of 10 minutes. The mixture was acidified by addition of 0.03% tosyl isocyanate. The reaction was continued for 22 hours at a reaction temperature of 60° C. (thermostat) and for 4 hours at a reaction temperature of 130° C.

The NCO:OH ratio is shown in the “Index” column of Table 1.

TABLE 1

| Product | Index | Reaction temperature | Catalyst | MDI content |
|---|---|---|---|---|
| A | 1.7 | 130° C. | None | 1.4% |
| B | 1.7 | 60° C. | None | 0.9% |
| C | 1.5 | 130° C. | None | 0.5% |
| D | 1.5 | 60° C. | None | 0.2% |
| E | 1.5 | 60° C. | 0.1% DMDEE | 0.18% |
| F | 1.5 | 60° C. | 0.01% DBTL | 0.06% |

TABLE 2

NCO content

| Product | Theoretical | Observed | Viscosity at 130° C. |
|---|---|---|---|
| D | 3.66% | 3.52% | 210 mPas |
| F | 3.66% | 3.35% | 370 mPas |

### 2. Reaction of the Reactive Polyurethanes with Polyols

The reactive polyurethane F (Table 1) and commercially available pure 4,4′-MDI were reacted with a hydroxyfunctional polyester of dodecanedioic acid and hexane-1,6-diol with an OH value of 30 in known manner at a reaction temperature of 130° C. and an index value of 2.2.

TABLE 3

| | PU Composition of DYNACOLL 7380 and | |
|---|---|---|
| | Product F (invention) | 4,4′-MDI (comparison) |
| Viscosity at 130° C. | 24,800 mPas | 6,200 mPas |
| Open time | 70 s | 45 s |
| Setting time | 25 s | 25 s |
| MDI monomer | <0.1% (at detection limit) | 2.9% |
| content | | |

The PU composition of Table 3, column 1 shows favorable properties as a reactive hotmelt adhesive.

Adhesion to plastics, such as for example ABS and flexible PVC films for the sheathing of window profiles, is very good, even after ageing for 7 days at 95° C./5% relatve humidity. By contrast, the PU composition of Table 3, column 2 becomes brittle and peels off.

What is claimed is:

1. A process for producing a reactive polyurethane containing free isocyanate groups which comprises reacting a monomeric asymmetrical diisocyanate with a polyhydric alcohol, wherein:
(a) diphenylmethane-2,4′-diisocyanate (2,4′-MDI) containing less than 5% 4,4′-MDI and 2,2′-MDI, the 2,2′-MDI content being under 0.4%, is used as the monomeric asymmetrical diisocyanate;
(b) at least one diol with a molecular weight of 60 g/mol to 2,000 g/mol is used as the polyhydric alcohol; and
(c) the ratio of isocyanate groups to hydroxyl groups is a value of 1.05:1 to 2.0:1.

2. A process as claimed in claim 1, wherein the reactive polyurethane has a Brookfield viscosity at 100° C., as measured by ISO 2555, in the range from 20 mPas to 3,000 mPas.

3. A process as claimed in claim 1, wherein the content of monomeric asymmetrical diisocyanate in the reactive polyurethane is at most 0.3% by weight.

4. A process as claimed in claim 1, wherein at least one linear or lightly branched C₂₋₁₈ alkanediol is used as the diol.

5. A process as claimed in claim 1, wherein said reacting is carried out in the presence of at least one catalyst selected from the group consisting of organometallic compounds of tin, lead, iron, titanium, bismuth and zirconium.

6. A process as claimed in claim 1, wherein said reacting is carried out between 30° C. and 130° C. in the presence of a tin(IV) compound as catalyst.

7. A process as claimed in claim 1, wherein said reacting is carried out at 40 to 75° C.

8. A process as claimed in claim 1, wherein the ratio of isocyanate 30 groups to hydroxyl groups is adjusted to a value of 1.05:1 to 1.5:1.

9. A process as claimed in claim 1, wherein said reacting is carried out between 25° C. and 100° C.

10. A process as claimed in claim 1, wherein said at least one diol contains secondary hydroxy groups.

11. A process as claimed in claim 1, wherein said reacting is carried out in the presence of an aprotic solvent.

12. A process as claimed in claim 1, wherein said reactive polyurethane contains not more than 0.1% by weight asymmetrical diisocyanate.

13. A process as claimed in claim 1, wherein the reactive polyurethane has an NCO content of from 4.5 to 10% NCO.

14. A process as claimed in claim 1, wherein said at least one diol has a molecular weight of 200 g/mol to 1,500 g/mol.

15. A process as claimed in claim 1, wherein said at least one diol is a polyether.

16. A process as claimed in claim 1, wherein said at least one diol is selected from the group consisting of reaction products of low molecular weight polyhydric alcohols and alkylene oxides containing 2 to 4 carbon atoms.

17. A process as claimed in claim 1, wherein said at least one diol is polypropylene glycol.

18. A process as claimed in claim 1, wherein the ratio of isocyanate groups to hydroxyl groups is adjusted to a value of 1.4:1 to 1.9:1.

19. A process as claimed in claim 1, comprising the additional step of reacting the reactive polyurethane with a polyol.

20. A process as claimed in claim 1, comprising the additional step of reacting the reactive polyurethane with a polyester polyol.

21. A process as claimed in claim 1, comprising the additional step of combining the reactive polyurethane with at least one additional component selected from the group consisting of catalysts, polymeric compounds, stabilizers, adhesion-promoting additives, fillers, pigments, plasticizers, and solvents.

22. A process as claimed in claim 1, wherein the monomeric asymmetrical diisocyanate contains at least 97.5% 2,4′-isomers of MDI.

23. A process as claimed in claim 1, wherein at least one polyol selected from the group consisting of glycerol, trimethylol ethane, trimethylol propane, pentaerythritol, sugar alcohols, and polyether polyols having molecular weights of 100 g/mol to 1,800 g/mol formed by reacting one or more alkylene oxides with glycerol, trimethylol ethane, trimethylol propane, pentaerythritol, sugar alcohols or mixtures thereof is additionally reacted with the monomeric asymmetrical diisocyanate.

24. A process as claimed in claim 1, wherein at least one polyol having a number average molecular weight of 2,000 g/mol to 20,000 g/mol selected from the group consisting of polyesters, polyethers, polyacetals, and polycarbonates is additionally reacted with the monomeric asymmetrical diisocyanate.

25. A reactive polyurethane containing free isocyanate groups obtained by the process of claim 1.

26. A two component sealant/adhesive comprising at least, one reactive polyurethane as claimed in claim 1 and at least one hardener.

27. A moisture-curable sealant/adhesive comprising at least one reactive polyurethane as claimed in claim 1 and at least one aliphatic tertiary amine.
